(19) United States
(12) Patent Application Publication
(10) Pub. No.: US 2009/0041279 A1
(43) Pub. Date: Feb. 12, 2009

(54) Acoustic ear tube retainer spring

(76) Inventor: John W. Davis, South Windsor, CT (US)

Correspondence Address: Donald W. Meeker;Patent Agent, 924 East Ocean Front #E, Newport Beach, CA, 92661, US

(21) Appl. No.: 11/891,012

(22) Filed: Aug. 8, 2007

(51) Int. Cl. H04R 25/00

(52) U.S. Cl. 381/328

(57) ABSTRACT

A metal retainer spring bent into a U-shape retains an acoustic ear tube for use with behind-the-ear devices. The tube is held by a tube retaining opening in a tapered mid portion, forming the curved portion of the bent spring, and end slots bent together with the slots holding the tube. The retainer spring fits into the human ear canal for securing a narrow acoustic ear tube within a user's ear canal. The spring is manufactured from beryllium copper, or other material with excellent strength and great elasticity, and is then gold plated for the hypoallergenic properties. The top and bottom ear canal-contacting surfaces of each spring have a pebbled or rippled finish to limit slippage without causing abrasions.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to ear inserts for hearing aids, acoustic devices, and Bluetooth or hands-free cellular phones and particularly to a metal retainer spring for an acoustic hearing tube for use with behind-the-ear devices, wherein the retainer spring is adapted to fit into the human ear canal for securing a narrow acoustic ear tube device within a user's ear canal and the spring is manufactured from beryllium copper, or other material with excellent strength and great elasticity, and is then gold plated for the hypoallergenic properties, and the top and bottom ear canal-contacting surfaces of each spring have a pebbled or rippled finish to limit slippage without causing abrasions.

2. Description of Related Art

including information disclosed under 37 CFR 1.97 and 1.98

Ear molds or ear buds for hearing aids, acoustic devices or cell phones are well known in the art. Currently, there are many ear pieces that are made of silicone or other soft materials. Most of the soft ear pieces have a problem with retention. They are made to be soft so that they will fit into the ear without causing discomfort or irritation, but often do not hold the ear piece securely in place. Ear canal device holders have been proposed which are made of flexible silicone material, such as that found in U.S. Pat. No. 5,572,594 issued to Devoe.

The newest style of hearing aid is called the open fit or the over the ear aid. Processing of sound is done by the device that sits outside the ear canal. The sound is transferred into the canal via a thin tube.

The biggest problem with this style of aid is to get the tube to stay within the ear canal. This is critical to the looks and performance of the device. Every manufacturer has a different style ear mold to hold the tube in place. All the molds are made of silicone or latex.

The molds are soft so that they can conform to the unique shape of the ear canal. Most ear molds are domes or half round spheres. All of them are designed to let air and sound flow into and out of the ear naturally. All current product designs use soft plastic domes, caps or umbrellas. The devices are usually comfortable, but all of them slip out of the ear. Pressure and slippage are problems with snug fitting plastic devices. Most of the soft ear pieces have a problem with retention. The are made to be soft so that they will fit into the ear without causing discomfort or irritation.

If the mold is too tight within the ear canal, it can cause irritation or discomfort. If the mold is made without enough airflow, the user's voice will sound muffled and distorted. If the device is too loose, the mold can slip out of position. Molds out of position can cause feedback: (a high pitch whistle), and the aid will become more conspicuous because of noise the aid is generating. If the mold works it way out of position, the tube then protrudes out and is not cosmetically attractive.

The prior art does not adequately solve all of the problems.

U.S. Pat. No. 7,076,076, issued Jul. 11, 2006 and two U.S. Patent Applications, #20040047483 and #20040047482 published Mar. 11, 2004 all from Bauman, concern a hearing aid system for improving a user's hearing and more particularly a receiver system used in the system. In one embodiment, the receiver system has a housing and a plurality of arms extending from the housing for positioning and suspending the receiver within the ear canal of a user. Each of the arms may be formed from a flexible, plastic material or a bendable wire. In a second embodiment, the receiver system is surrounded by a disc formed from a sound filtering material. When installed in a combination instrument, the receiver is separated from the microphone. When installed in a tinnitus/hyperacusis device, the receiver is separated from the body of the instrument.

U.S. Patent Application #20070036374, published Feb. 15, 2007 by Bauman, illustrates a hearing aid system which includes a receiver unit configured and positioned within the user's ear canal so as to minimize insertion loss and/or occlusion effect. With regard to FIGS. 9 and 10, at least one spring is provided on a portion of the receiver unit. When the receiver unit is installed within the ear canal, the spring may contact a wall of the ear canal to facilitate positioning of the receiver unit within the ear canal. Also, multiple springs can be positioned for receiver unit placement inside the ear canal. Such spring may be positioned anywhere on the receiver unit, or indeed, on a portion of the intermediate connecting portion provided within the ear canal.

U.S. Pat. No. 5,572,594, issued Nov. 5, 1996 to Devoe, shows an ear canal device holder for devices other than speaker/microphone amplification systems that are to be inserted into the canal of the human ear. The device holder is made of a flexible silicone material comprising a body and structural support element(s) such that the device is held within the body of the holder and the body and device are secured in the ear by the structural element(s). In addition the device holder minimizes the attenuation of sound waves that pass through the ear canal to the tempanic membrane, while maximizing comfort and secure fit.

U.S. Pat. No. 6,773,405, issued Aug. 10, 2004 to Fraden, is for a continuous body core temperature monitor comprises a pliable ear plug that conforms to the shape of an ear canal and incorporates a temperature sensor that is clamped between the plug and the ear canal wall. The external surface of the plug is connected to an external temperature sensor and a heating element that compensate for a heat lost from the ear canal to the environment by maintaining the temperature gradient between the temperature sensor and the heating element close to zero. Another possible embodiment of the plug is shown in FIG. 5 where the plug is made in shape of flexible fork having a spring action. The end of the fork is squeezed by fingers before the insertion and let go after.

What is needed is an acoustic ear tube retainer spring structured to eliminate the problems of prior art devices

### BRIEF SUMMARY OF THE INVENTION

An object of the present invention is to provide a metal retainer spring for an acoustic hearing tube for use with behind-the-ear devices, wherein the retainer spring is adapted to fit into the human ear canal for securing a narrow acoustic ear tube device within a user's ear canal and the spring is manufactured from beryllium copper, or other material with excellent strength and great elasticity, and is then gold plated for the hypoallergenic properties, and the top and bottom ear canal-contacting surfaces of each spring have a pebbled or rippled finish to limit slippage without causing bruising or abrasion.

Another object of the present invention is to provide a metal retainer spring for an acoustic hearing tube for use with behind-the-ear devices that may be manufactured in a variety of sizes to accommodate various ear canal sizes.

One more object of the present invention is to provide a metal retainer spring for an acoustic hearing tube for use with behind-the-ear devices that is more durable than current in-the-ear devices.

An additional object of the present invention is to provide a metal retainer spring for an acoustic hearing tube for use with behind-the-ear devices that is more adjustable to various ear canal sizes.

In brief, a metal retainer spring retains an acoustic ear tube for use with behind-the-ear devices. The retainer spring fits into the human ear canal for securing a narrow acoustic ear tube device within a user's ear canal. The spring is manufactured from beryllium copper, or other material with excellent strength and great elasticity, and is then gold plated for the hypoallergenic properties. The top and bottom ear canal-contacting surfaces of each spring have a pebbled or rippled finish to limit slippage without causing bruising or abrasion.

The present invention is structured to eliminate the problems of prior art devices. The spring is made to be taller than it is wide. Ear canals are not perfectly round; most ear canals tend to be oblong. The canal usually has two areas that are smaller that the rest of the canal.

The first narrow portion of the canal is at the very opening of the ear canal. At this position, the greatest amount of flesh is found. This loose skin has a small amount of movement or flexibility.

Most ear canals are slightly over one inch in length. Just before the eardrum or tympanic membrane, there is another narrowness called the isthmus. This area has the least amount of skin covering the bone beneath. Any penetration to or beyond this point usually causes discomfort.

The acoustic ear tube retainer spring of the present invention fits just beyond the opening. It will allow the device to fit in the canal and exert slight expansion up and down on the soft pliable skin. The location of the retainer spring is within the area that has cartilage below the surface of the skin and is not as susceptible to discomfort. The length of the ear spring should give resistance to movement within the ear canal.

The length of the retainer spring is also designed to add comfort to the wearing of the device. Because the retainer spring is exerting pressure on the canal to stay in place, the slight tension is spread over a large area.

To get maximum cosmetic appeal to the device, the inner end of the retainer spring is tapered. This will allow it to penetrate up to the isthmus of the canal. Manufacturers will decide how far they want their tubes to protrude beyond the retainer spring. The device would preferably never protrude more that 1/8 of an inch beyond the hole provided, because of the proximity of the eardrum.

The slots on the exterior ends of the retainer spring are tapered. This allows a tube to be inserted at the widest portion of the opening, then raised up to be locked in place through friction. Because the present invention is made to be universal with all hearing aid manufacturers and telephone and other audio products, each tube has a molded piece on the tube. The molded piece fits between the slots on the exterior and the aperture on the interior of the retainer spring.

An advantage of the present invention is that it retains the acoustic ear tube securely in place without slippage in a portion of the ear canal which does not cause discomfort.

Another advantage of the present invention is that it and admits air and sound into the inner ear.

One more advantage of the present invention is that it eliminates pressure from snug fitting plastic devices and eliminate the slippage that is the most prevalent problem.

An additional advantage of the present invention is that it is made in a variety sizes to accommodate various different ear canal sizes.

A further advantage of the present invention is that it is more durable than other in-the-ear devices.

A contributory advantage of the present invention is that it is more adjustable than current in-the-ear devices.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a top plan view of the retainer spring of the present invention in a flat configuration prior to bending the retainer spring for use;

FIG. 2 is a side elevational view of the retainer spring of the present invention with the retainer spring in a bent configuration for use;

FIG. 3 is a perspective view of the retainer spring of the present invention with the retainer spring in a bent configuration for use showing an acoustic ear tube inserted through the opening in the curved forward end and the opening formed by bending the two double prong ends together in an overlapping relationship;

FIG. 4 is a perspective view of the retainer spring of the present invention with the retainer spring in a bent configuration for use showing an acoustic ear tube inserted through the opening in the curved forward end and the opening formed by bending the two double prong ends together in an overlapping relationship and showing the retainer spring and acoustic ear tube inserted into an auditory canal shown in partial section.

### DETAILED DESCRIPTION OF THE INVENTION

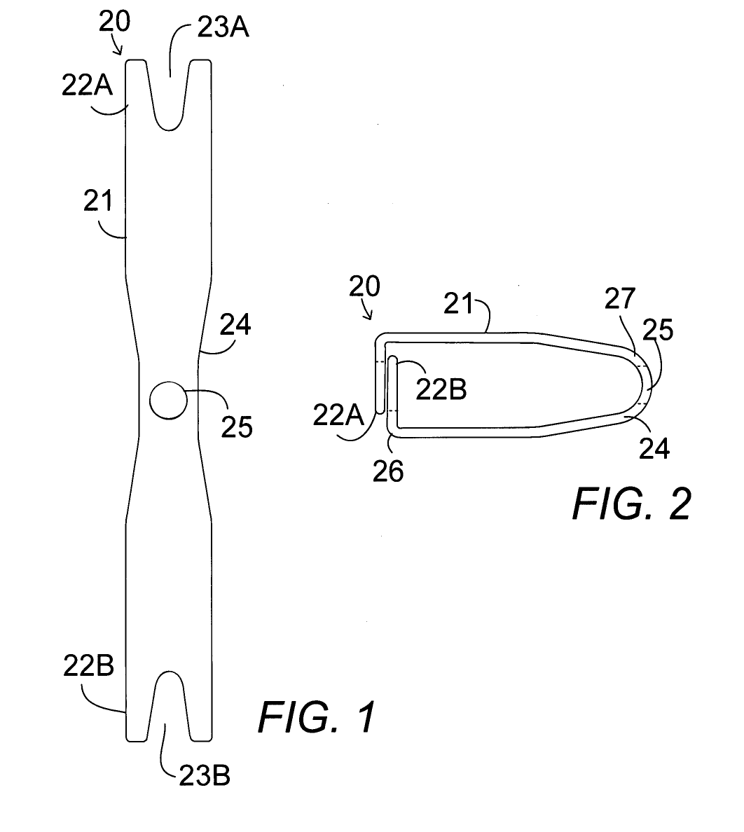

In FIGS. 1-4, an acoustic ear tube retainer spring device 20 comprises a U-shaped bent retainer spring body 21 with an end opening 25 and bent-over spaced pronged ends 22A and 22B with overlapping tapered end slots 23A and 23B to retain a 1 mm acoustic ear tube 30 in the external auditory meatus of the ear canal 10 of a user's ear 11 spaced apart from the ear drum 12, as shown in FIG. 4.

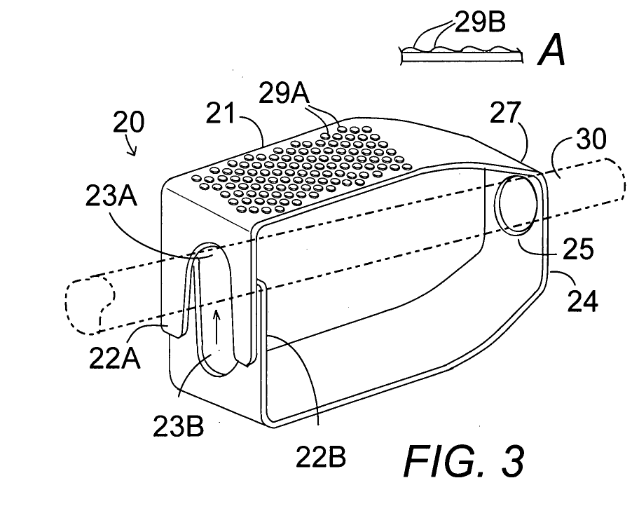

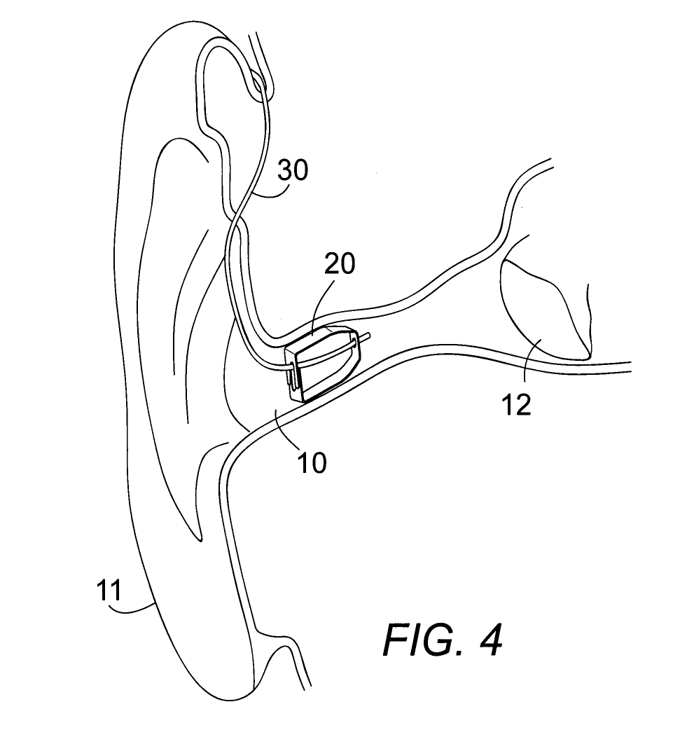

The retainer spring comprises an elongated strip of spring metal having substantially parallel side edges along the length of the elongated strip tapering to a narrow waist in a mid portion 24 having a center opening 25 through the mid portion to admit therethrough and retain therein the acoustic ear tube 30, and an open tapered slot 23A and 23B at each end of the elongated strip. The retainer spring bends into a U-shape for insertion into the ear canal of a user with the mid portion forming the curve 27 of the U-shape, which is inserted first. The parallel side portions contact the top and bottom portions of the external auditory meatus 10 of the ear canal and the two ends 22A and 22B bend inwardly toward each other at bend points 26, as shown in FIG. 2. The tapered end slots 23A and 23B fit over the acoustic ear tube 30, which can be pressed into a narrow portion of one of the tapered end slots 23A to bind the acoustic ear tube to the retainer spring with a friction fit, as shown in FIG. 3, to further assist in retaining the acoustic ear tube 30 with friction, to prevent the acoustic air tube 30 from slipping out of the ear canal while admitting air and sound to pass through the ear canal on both sides of the tapered waist mid portion 24.

The retainer spring is preferably made of beryllium copper for its excellent strength and elasticity, and is gold plated to provide hypoallergenic properties and to provide greater adaptation to body temperature.

The surfaces of the retainer spring that contact the ear canal preferably have textured finishes to limit slippage without causing abrasions. The textured finishes may comprise pebbled finishes 29A, as is FIG. 3, or rippled finishes 29B, as in FIG. 3A.

In use, the acoustic ear tube spring retainer of the present invention is bent into a curve at the mid portion 24, and at the bend points 26 of the two pronged ends 22A and 22B, aligning the two overlapping tapered end slots 23A and 23B, to form a tapered opening that is aligned with the end opening 25. An acoustic ear tube 30 is inserted through the two aligned openings and pressed into a narrow portion of one of the tapered end slots. The bent spring is then inserted into the ear of a user, with the curve 27 of the U-shaped end inserted first, and the parallel side pieces of the spring contacting the top and bottom of the user's ear canal, with a minimum of pressure. The textured surfaces 29A and 29B of the spring device help to secure the device to the soft tissue of the top and bottom of the user's ear canal. By contacting the top and bottom of the ear canal, the spring device avoids the discomfort of possible bruising and abrading the sides of the canal, which have far less soft tissue. The spring device is designed to be used with a high frequency hearing aid or a blue tooth telephone ear piece, or any other device with an acoustic ear tube 30 attached carrying the amplification from the device into the ear canal.

A variety of different sizes of spring can accommodate the various sizes of people's ear canals.

It is understood that the preceding description is given merely by way of illustration and not in limitation of the invention and that various modifications may be made thereto without departing from the spirit of the invention as claimed.

What is claimed is:

1. An acoustic ear tube retainer spring device comprising:
a retainer spring comprising an elongated strip of spring metal having substantially parallel side edges along the length of the elongated strip tapering to a narrow waist in a mid portion having a center opening through the mid portion to admit therethrough and retain therein the acoustic ear tube and an open tapered slot at each end of the elongated strip so that the retainer spring bends into a U-shape for insertion into an ear canal of a user with the mid portion forming the curve of the U-shape which is inserted first, the parallel side portions contact a top and bottom portions of the external auditory meatus of the ear canal and the two ends bend inwardly toward each other so that the end slots fit over the acoustic ear tube which is pressed against a narrow inner end of one of the tapered slots for a friction fit to further assist in retaining the acoustic ear tube to prevent the acoustic air tube from slipping out of the ear canal while admitting air and sound to pass through the ear canal on both sides of the tapered waist mid portion.

2. The device of claim 1 wherein the retainer spring is made of beryllium copper for strength and elasticity.

3. The device of claim 1 wherein the retainer spring is gold plated for the hypoallergenic properties.

4. The device of claim 1 wherein the ear canal contacting surfaces of the retainer spring have textured finishes to limit slippage without causing abrasions.

5. The device of claim 4 wherein the textured finishes comprise pebbled finishes.

6. The device of claim 4 wherein the textured finishes comprise rippled finishes.
